(19) United States
(12) Patent Application Publication
(10) Pub. No.: US 2009/0238157 A1
(43) Pub. Date: Sep. 24, 2009

(54) Enhanced scanning for access entities

(75) Inventors: Jari Pöyhonen, Tampere (FI); Mikko Jaakkola, Lempaala (FI); Arto J. Soumi, Finland (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/921,108

(22) PCT Filed: May 23, 2006
(86) PCT No.: PCT/IB2006/051648

§ 371 Date: Nov. 27, 2007

(30) Foreign Application Priority Data
May 31, 2005 (EP) 05011723.3
Jul. 29, 2005 (GB) 0515627.8

(51) Int. Cl. H04W 84/02

(52) U.S. Cl. 370/338

(57) ABSTRACT

The invention proposes a method for detecting an access entity in a network comprising the access entity and a device for wireless communication, wherein the detection is performed with respect to a changeable parameter, and for each specified parameter the following steps are performed: buffering data packets to be transmitted between the device for wireless communication and the access entity, performing the scan process, by the device for wireless communication, based on the specified parameter, and transmitting the buffered packets between the device for wireless communication and the access entity. The invention also proposes a corresponding device for wireless communication.

### BACKGROUND OF THE INVENTION

1. Field of the Invention

The invention relates to a method and a device for wireless communication by which a scan for access entities can be performed.

2. Description of the Related Art

This invention is related to a network in which a device for wireless communication may establish a connection to one of several different access entities. An example is Wireless Local Area Network (WLAN), in which a WLAN device (also referred to as station (STA)) may be connected to different Access Points (APs). In this scenario, roaming of the WLAN device between different APs is possible. When roaming in WLAN networks, the user usually needs to perform a background active directed scan operation in order to discover the available WLAN access point to roam to.

That is, when such a WLAN device prepares for roaming, it usually performs a background active directed scan in order to discover the available WLAN access points belonging to the same WLAN network (having the same network name (SSID (Service Set IDentifier))). One scan operation performed by the WLAN device can take around 1 second.

The scan operation can either be active or passive. In the active scan operation, probe frames are sent and it is waited for a response, and in the passive scan operation, the WLAN device listens for specific data frames such as beacons from an Access Point.

The active scan operation is illustrated in FIG. 6. This operation is performed in each channel. In particular, between a WLAN device (i.e., a terminal) and an Access Point operating on frequency 1, data transmission is performed. Then, for performing the scan operation, the frequency is tuned to frequency 2. On this frequency, a probe request is sent to the wireless medium. In case an Access Point operating on the frequency 2 is available, it will answer with a Probe response. This is repeated for frequency 3 . . . until frequency N is achieved.

While doing scan operation, sending and receiving of data MPDUs (MAC (Medium Access Control) Protocol Data Unit) is not possible, and this has a direct effect to applications that have real time requirements like voice.

### SUMMARY OF THE INVENTION

Hence, it is an object of the present invention to solve the problem mentioned above and to minimize the delay for applications with realtime requirements during a scan for access entities.

This object is solved by a method for detecting an access entity in a network comprising the access entity and a device for wireless communication, wherein the detection is performed with respect to a changeable parameter, and for each specified parameter the following steps are performed: buffering data packets to be transmitted between the device for wireless communication and the access entity, performing a scan process, by the device for wireless communication, based on the specified parameter, and transmitting the buffered packets between the device for wireless communication and the access entity.

Alternatively, the object is solved by a device for wireless communication for connecting to an access entity, comprising detection means for detecting an access entity in a network, wherein the detection is performed with respect to a changeable parameter, and the detection means is adapted to perform, for each specified parameter, the following sequence of operations: sending an indication to the access entity to buffer data packets to be transmitted from the access entity to the device for wireless communication, performing the scan process based on the specified parameter, and receiving the buffered packets from the access entity.

Thus, according to the invention, the data frames are buffered (in the access entity and/or the device for wireless communication), so that a scan process can be carried out with respect to one specified parameter. After the scan, the buffered packets are transmitted. The parameter can be a channel and/or frequency, for example. That is, the above processes may be carried out for one channel, so that a scan process is carried out for one channel, and after this, the buffered packets are forwarded. Thereafter, the packets are buffered again and the scan operation is carried out for another channel.

Hence, the delay caused by the scan is reduced to a minimum. That is, according to the invention disturbances to the data traffic are minimized.

Further advantageous developments are set out in the dependent claims.

In particular, the device for wireless communication may be connected to a specific access entity, and the detection may be performed with respect to a further access entity. That is, in this example the detection is performed upon roaming of the user of the device for wireless communication.

Moreover, the parameter may comprise frequency and/or channel and/or identity of a specific wireless network. That is, the sequence of operations as described above may be carried out for a specific frequency, for a specific channel and/or a specific identity of a wireless network (SSID ((Service Set IDentifier), for example)

Upon carrying out the buffering step, the following may be carried out: in the specific access device, a data frame is received from the device for wireless communication, the data frame comprising an indication that frames are to be buffered, and data frames destined to the device for wireless communication are buffered by the specific access device. The indication described above may a power management bit being set.

Furthermore, after receiving an indication from device for wireless communication that the scan process with respect to the specified parameter is completed, the buffered packets may be sent to the device for wireless communication. This particular indication that the scan process with respect to the parameter is completed may be a reception of a Poll frame, a frame with power management bit cleared, for example.

In case the device for wireless communication itself has frames to be sent to the access entity during the scan process, these may buffered in the device, and after the scan process, these buffered frames may be sent to the access entity.

The scan process may comprise the steps of sending a probe frame and waiting for a response. That is, the scan process may be an active scan.

Alternatively, the scan process may comprises the step of waiting for reception of a specific frame. This may be, for example, a passive scan in which the specific frame is a beacon from an Access Point

Moreover, the network may be a Wireless Local Area Network (WLAN), the access entity may an Access Point (AP) and the device for wireless communication may be a WLAN device.

Furthermore, the detection may be started upon receiving a request from a host device hosting the device for wireless communication.

The detection means of the device for wireless communication may comprise a control block, a transceiver, an antenna and a memory.

The method according to the invention may be realized as a computer program product for a processing device, comprising software code portions for performing the steps of the method according to the invention when the program is run on the processing device. The computer program product may comprise a computer-readable (readable for the processing device) medium on which the software code portions are stored.

In particular, the processing device may be part of a WLAN device, so that the computer program may be stored in a memory of the WLAN device.

### BRIEF DESCRIPTION OF THE DRAWINGS

The invention is described by referring to the enclosed drawings, in which:

FIG. 1 shows a basic structure of a WLAN comprising a WLAN device and several Access Points,

FIG. 2 shows a flow chart of a procedure carried out in the WLAN device according to an embodiment of the present invention,

FIG. 3 shows a flow chart of a procedure carried out in an Access Point according to the embodiment of the present invention,

FIG. 4 illustrates a WLAN host API architecture as applicable in the embodiment of the invention,

FIG. 5 shows a terminal according to the embodiment of the invention, and

FIG. 6 shows a signalling flow of performing a scan to multiple channels.

### DETAILED DESCRIPTION OF THE PREFERRED EMBODIMENT

In the following, a preferred embodiment of the present invention is described by referring to the attached drawings.

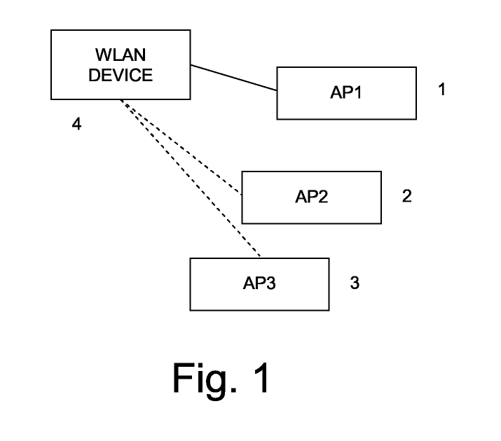

According to the preferred embodiment, the invention is applied to a Wireless Local Area Network (WLAN) having a structure in the way as shown in FIG. 1, for example. In particular, a WLAN device 4 (as an example for a device for wireless communication) is connected via radio with a first Access Point AP1 (as an example for an access entity), denoted by reference numeral 1. In this situation it is assumed that the user of the WLAN device would like to roam. For this, it is necessary to carry out a scan operation in order to detect other access points, such as the access points AP2 and AP3 (as examples for further access entities), for example.

It is noted that the WLAN device can be a WLAN card to be inserted in a laptop computer, in a PDA (personal digital assistant), a mobile phone, a USB (Universal Serial Bus) stick inserted in a USB port of a laptop computer or a fixed personal computer or the like. In these cases, the laptop computer and the fixed personal computers are examples for host devices. Furthermore, the WLAN device can itself be a laptop computer having an on-board WLAN functionality, a WLAN enabled phone or the like. In these cases, the WLAN device and the host device are arranged within one entity, and may only be logically separated.

According to the present embodiment, the scanning operation, when preparing for roaming, of the WLAN device is performed as follows:

First, a scan request is issued from the host device. The scan request according to the present embodiment is an enhanced scan request with respect to the scan request as defined, e.g., in IEEE 802.11 and commands the WLAN device to start scanning in order to determine the characteristics of the available BSSs (Basic Service Sets) and IBSSs (Independent Basis Service Sets) to which it may later to elect to join.

For each channel (as an example for a parameter with respect to which the scanning is performed), the WLAN device sends a frame to the AP, to which it is connected (i.e., in the example of FIG. 1 AP1) with the power management bit set to inform it to buffer frames that are destined to it. Then the device starts the active directed scanning of one channel (i.e., the scan process) at a time. When the scan process finishes for this channel, the WLAN device informs the AP that it can stop buffering the frames and also sends any possible frames from its own transmission queue to the AP. The time to scan one channel usually takes around 20-75 milliseconds as defined by the MinChannelTime and the MaxChannelTime as defined by IEEE 802.11 (as parameters of the scan request).

It is noted that the power management bit is a field defined in the frame control field of the header of a frame, as defined in IEEE 802.11.

According to the present embodiment, it is proposed to add such semantics to the scan request that allows the WLAN device to send and receive MPDUs between the channels it is scanning. After the WLAN device has scanned one channel it joins back to the AP where it is connected to and enables the MPDU sending and receiving prior moving to the next channel to scan.

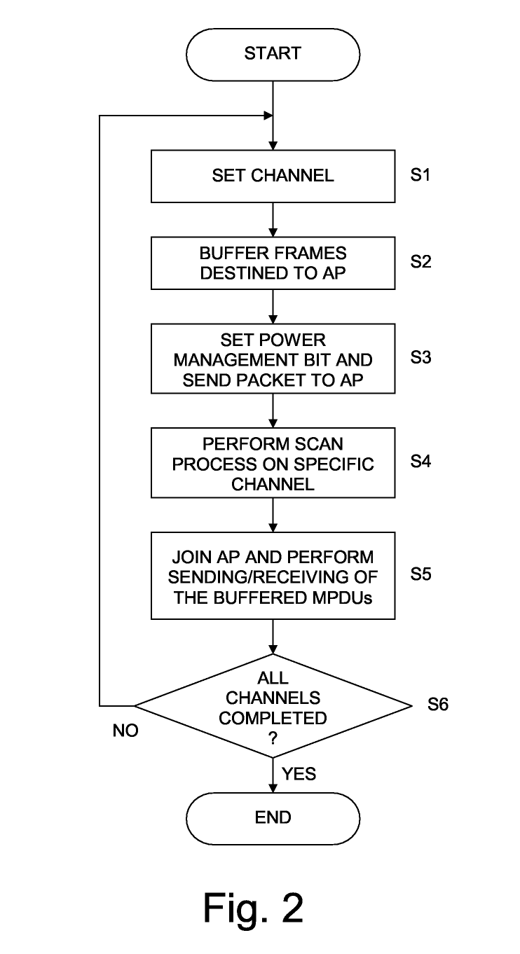

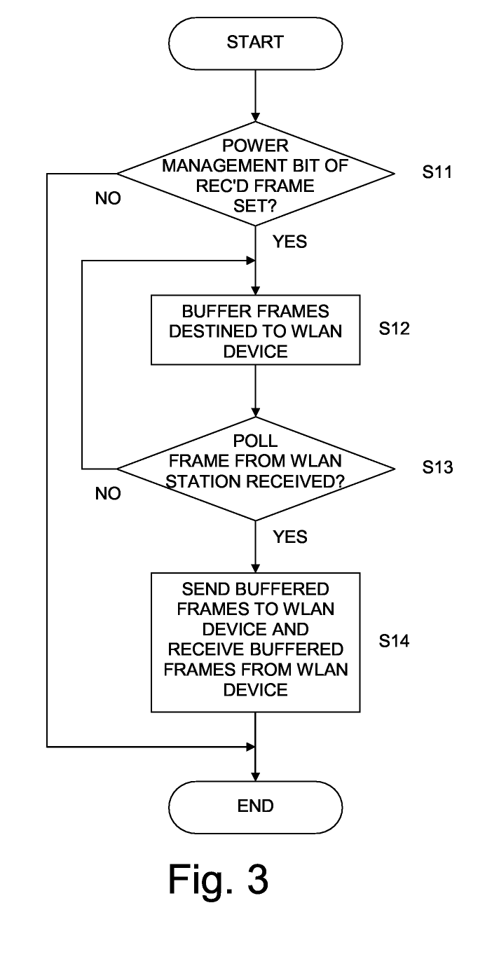

This is described in the following by referring to the flow charts shown in FIGS. 2 and 3.

FIG. 2 shows the scan operation from point of view of the WLAN device. In step S1, a channel is set, on which the scan process is to be carried out. In step S2, the power management bit of a data frame to be sent to the AP is set, and the packet is sent to the AP. This will indicate to the AP that the subsequent packets intended for the WLAN device should be buffered, as described above. In step S3, the operation state of the WLAN device is set such that subsequently the frames destined to the AP are buffered in the WLAN device.

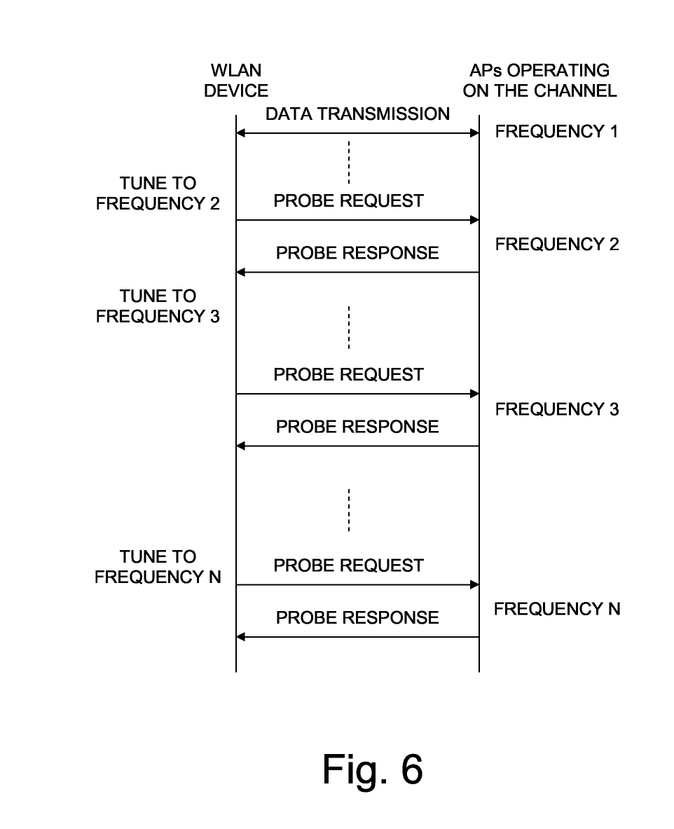

In step S4, the actual scan process is carried out for the specific channel (i.e., the channel set in step S1). According to the present embodiment, the scan process is active. That is, probe requests are sent to the wireless medium (WM), and it is checked for probe responses, similar as in the way shown in FIG. 6. However, the scan process is carried out only for one channel.

Thereafter, the procedure advances to step S5, in which the WLAN device joins again the AP (AP1 in FIG. 1), by sending a join request (as defined in IEEE 802.11), for example. Then, the WLAN device may receive those packets which were buffered by the AP, and may send those packets which were buffered in the own transmission queue of the WLAN device.

In step S6, it is checked whether all desired channels have been checked. If not, the procedure returns to step S1, in which a new channel is set and the following steps are repeated. If all desired channels have been checked, then the procedure ends.

It is noted that the condition that all channels have been checked is only an example for a stop condition in step S6. Instead, also other stop conditions are possible, for example, that a suitable AP has been found. That is, in this case, in the active scan process a probe response has been received and it has been determined that the AP (e.g., AP3 in FIG. 1) provides a suitable connectivity (i.e., sufficient transmission quality, which can be measured by received signal strength from the AP).

In the following, the scan operation is described with respect to the flow chart shown in FIG. 3 from the point of view of the Access Point to which the WLAN device is connected (e.g., AP1 in FIG. 1). This procedure may be triggered each time a frame is received, for example.

In step S11, the AP checks whether it has received a frame in which the power management bit is set (i.e., a frame sent by the WLAN device in step S3 of FIG. 2). If this is not the case, the procedure ends. However, if such a frame is received, the procedure advances to step S12, in which the subsequent frames, which are destined to the WLAN device, are buffered.

In step S13, it is checked whether a further frame has been received from the WLAN device which contains an indication that the buffered frames can now be sent to the WLAN device, i.e., that the scan process is finished. According to the present embodiment, this indication is a poll frame. If this is not the case, the procedure returns to step S12. If however a poll frame from the WLAN device has been received, then the procedure advances to step S14, in which the buffered frames are sent to the WLAN device. Moreover, in case the WLAN device has itself buffered frames, these frames are also received.

For receiving MPDUs from the AP, the device uses PS (Power Save) Poll frames, and monitors the More Data Bit (as defined in IEEE 802.11) from the received MPDU for determining whether another PS Poll message needs to be issued to receive another MPDU and so on. At least 1 PS Poll frame is always generated in this implementation for the device to probe for a frame from the AP. Depending if the AP has buffered data for the device, it will send it or not.

Alternatively, the frames or MPDUs (MAC (Medium Access Control) Protocol Data Units) which were buffered by the WLAN device, may be transmitted after the scan process for one channel from the transmission queue of the WLAN device with power management bit cleared in order to indicate the end of one scan process.

In particular, for the duration of the logical scan operation (all desired channels scanned) the power management bit is always set for Tx MPDUs (MPDUs sent from the WLAN device to the AP) according to the present embodiment. If there are no more channels to scan, then the setting or clearing the bit depends of the WLAN device (STA) desired 802.11 power save mode towards the AP (determined by the WLAN Host driver), as the last Tx MPDU can be used to inform about WLAN device 802.11 power save mode change. Additionally a special frame (802.11 NULL-data frame) is commonly used to inform the AP about WLAN device power management mode changes, in case the Tx queue is empty.

Thus, according to the present embodiment, the delay for application with real time requirements is minimized. This is achieved by introducing a host API (Application Programming Interface) for WLAN MAC and modifying WLAN device firmware code that allows specifying an enhanced scan request that allows the WLAN device to be requested to send and receive data MPDUs while performing the scanning operation.

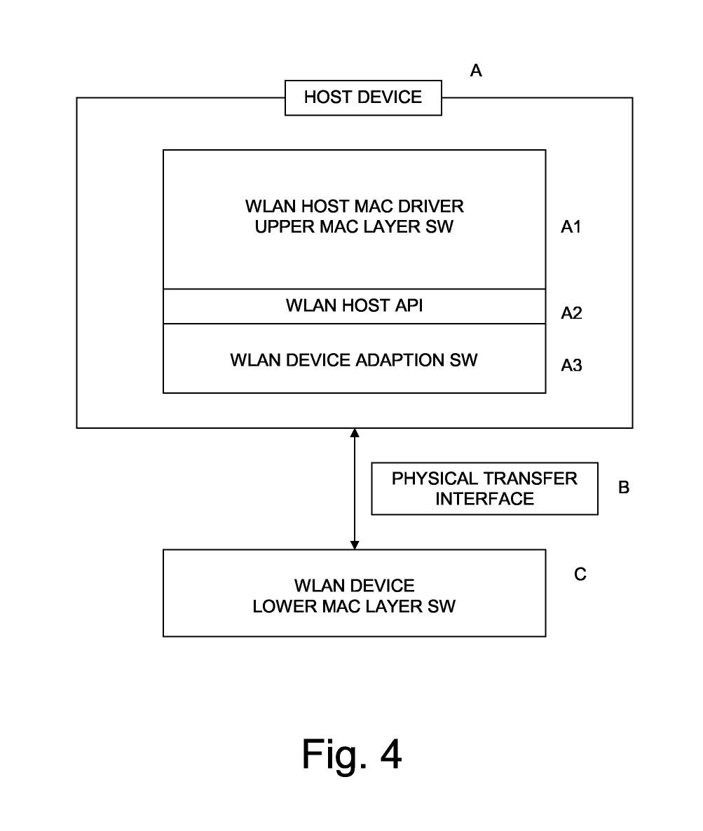

The host API and the WLAN device firmware code are described in the following in connection with FIG. 4, which shows the logical structure of a host device A and a WLAN device C.

The host device A, which hosts the WLAN device C, comprises the WLAN host MAC driver A1, which is an upper MAC layer software (SW). In this upper MAC layer, that MAC code is executed which has no or less strict real time requirements than the layers below it. The WLAN host API A2 mentioned above provides a connection to WLAN device adaptation software (SW) A3. This WLAN device adaptation software converts the logical WLAN operations defined by the WLAN host API to WLAN device specific commands and vice versa.

The host device A and the WLAN device C are connected via a physical transfer interface B (e.g., USB in case the WLAN device is included in a USB stick to be inserted in a USB port of a computer). In the WLAN device, the lower MAC layer software (SW) is carried out, and it is realized by the WLAN device firmware code, as mentioned above.

That is, actually the WLAN MAC is divided in two part in practise: part of the MAC is implemented as hardware based having firmware (i.e., the lower MAC layer software of the WLAN device) and part of the MAC is software based (i.e., the upper MAC layer software). Usually the software based MAC functions are not real-time functions so, less time critical.

In the enhanced scan request an additional field or parameter may be introduced which specifies whether the scan operation should be conducted in the way according to the present embodiment (i.e., for one channel at a time only) or in the way as known before (i.e., for all channels). This parameter could be called “SplitScan” for example, and can be a boolean variable. This name indicates that the actual scan operation is split, namely for each channel. Alternatively, also other forms are possible.

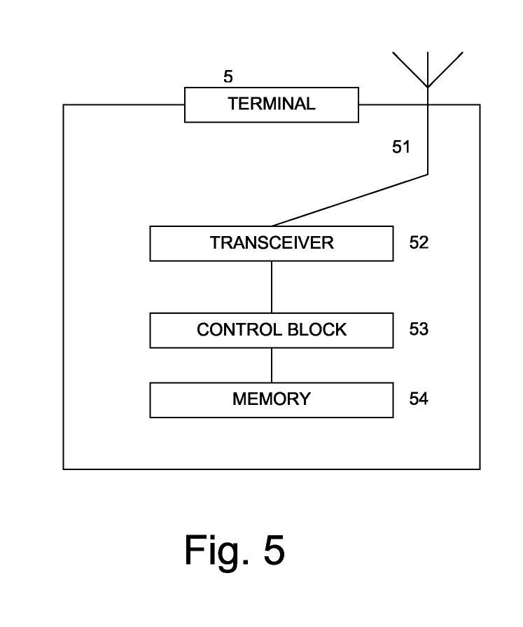

FIG. 5 shows a block diagram for a terminal according to the present embodiment. The terminal 5 comprises an antenna 51, a transceiver 52, a control block 53 and a memory 54. In detail, the control block 53 executes the code stored in the memory 54 (i.e., scanning, deciding operations based on received frames). Thus, as described above, the control block 53 executes a command to the transceiver 52 to operate in scanning mode as specified in the present embodiment. The transceiver 52 can be understood according to the present embodiment as at least a part of WLAN MAC layer and the Physical layer.

Furthermore, the invention also applies to chips capable of receiving commands through host API, to cause WLAN MAC chip to operate as described above. A WLAN device according to the present invention can be a device containing WLAN MAC and WLAN PHY layers and memory for storing software and a processor to execute the software.

The invention is not limited to the embodiment described above, and various modifications are possible.

For example, in the above-described embodiment, PS poll is used to trigger downstream data traffic. However, instead also U-APSD (Unscheduled Automatic Power Save Delivery) may be used as an upstream data packet which then triggers the downstream data traffic.

Moreover, according to the embodiment described above, both sending and receiving of MPDUs is performed. However, as an alternative, the transmission may be such that only sending or receiving is carried out. That is, the WLAN device would transmit MPDUs from its transmission queue with power management bit set, but would not poll for received data, or, alternatively, it would poll in order to receive data, but would not send MPDUs.

Another alternative of the embodiment described above would be informing the AP that the device has entered to 802.11 awake power management mode when doing the data transfer between the AP between the scanning process. In detail, according to IEEE 802.11, in order to change Power Management modes, the WLAN device informs the AP through a successful frame exchange initiated by the WLAN device. The Power Management bit in the Frame Control field of the frame sent by the WLAN device in this exchange indicates the Power Management mode (Awake Mode (AM) or Power Safe (PS)), i.e., that the WLAN device will adopt upon successful completion of the entire frame exchange.

Moreover, the invention is not limited to WLAN, but can also be applied to other radio networks in which it is necessary to perform a scan operation in order to detect a suitable access entity.

In addition, in the embodiment above, channel and/or frequency was described as a parameter with respect to which the scanning is performed. However, also other suitable parameters are possible. Alternatively, such a parameter can also be SSID (Service Set IDentifier) in such a way that the active scanning is performed on a list of SSIDs, where the probe requests are sent on each SSID at a time. The requests can take place on the same frequency or other channels.

Furthermore, in the above embodiment the example of roaming was described. However, the invention is also implementable in case the device for wireless communication (such as the WLAN device or station) is powered on and searches for other stations in an AdHoc network, for example. In this case, the buffering of packets, which have to be sent already to the other station (e.g., an Access Point), will only take place in the WLAN device. In this way, the set-up of a connection can be accelerated. In such case it is possible that the WLAN device establishes a connection to the first possible AP or another station to have some buffered data transmitted. Such a connection can be considered a temporary one, before the scan process is finished for a desired set of channels. After establishing such a temporary connection, the WLAN device can continue searching/scanning for other stations and APs on other channels, to find a station AP which would provide better connection quality than the first AP e.g. in signal quality sense. Measures for signal quality can be signal to noise ratio and received signal strength. The searching/scanning is continued through the desired set of channels according to the present invention and the process can include more temporary connections described above.

The invention can also be realized by computer program product. The computer program product, i.e., the computer code may be stored on a medium, e.g., a memory card, a RAM (Random access memory) or a ROM (read only memory) or a harddrive. For example, this computer program product may be stored in the memory 54 as shown in FIG. 5.

1. A method for detecting an access entity in a network comprising the access entity and a device for wireless communication, wherein the detection is performed with respect to a changeable parameter, and for each specified parameter the following steps are performed: buffering data packets to be transmitted between the device for wireless communication and the access entity, performing a scan process, by the device for wireless communication, based on the specified parameter, and transmitting the buffered packets between the device for wireless communication and the access entity.

2. The method according to claim 1, wherein the device for wireless communication is connected to a specific access entity, and the detection is performed with respect to a further access entity.

3. The method according to claim 1, wherein the parameter comprises frequency and/or channel and/or identity of a specific wireless network.

4. The method according to claim 2, wherein in the buffering step comprises the steps of receiving, in the specific access device, a data frame from the network device for wireless communication, the data frame comprising an indication that frames are to be buffered, and buffering data frames destined to the device for wireless communication by the specific access device.

5. The method according to claim 4, wherein the indication is a power management bit being set.

6. The method according to claim 1, wherein the transmitting step comprises the steps of sending the buffered packets to the device for wireless communication after receiving an indication from device for wireless communication that the scan process with respect to the specified parameter is completed.

7. The method according to claim 6, wherein the indication that the scan process with respect to the parameter is completed is a reception of a Poll frame.

8. The method according to claim 6, wherein the indication that the scan process with respect to the parameter is completed is a frame with power management bit cleared.

9. The method according to claim 1, wherein in the buffering step frames to be sent to the access entity are buffered in the device for wireless communication, and in the transmitting step, the buffered frames are sent to the access entity.

10. The method according to claim 1, wherein the scan process comprises the steps of sending a probe frame and waiting for a response.

11. The method according to claim 1, wherein the scan process comprises the step of waiting for reception of a specific frame.

12. The method according to claim 1, wherein the network is a Wireless Local Area Network (WLAN), the access entity is an Access Point (AP) and the device for wireless communication is a WLAN device.

13. The method according to claim 1, wherein the detection is started upon receiving a request from a host device hosting the device for wireless communication.

14. A device for wireless communication for connecting to an access entity, comprising detection means for detecting an access entity in a network, wherein the detection is performed with respect to a changeable parameter, and the detection means is adapted to perform, for each specified parameter, the following sequence of operations: sending an indication to the access entity to buffer data packets to be transmitted from the access entity to the device for wireless communication, performing the scan process based on the specified parameter, and receiving the buffered packets from the access entity.

15. The device according to claim 14, wherein the device for wireless communication is connected to a specific access entity, and the scan process is performed with respect to a further access entity.

16. The device according to claim 14, wherein the parameter comprises frequency and/or channel and/or identity of a specific wireless network.

17. The device according to claim 14, wherein the indication is a power management bit being set.

18. The device according to claim 14, further comprising a buffer means for buffering frames to be sent to the access entity during the scan process, and means for transmitting the buffered frames to the access entity after the scan process.

19. The device according to claim 14, wherein the detection means is adapted to send a probe frame and to wait for a response during the scan process.

20. The device according to claim 14, wherein the detection means is adapted to wait for reception of a specific frame.

21. The device according to claim 14, further comprising means to include an indication into a frame to be sent to the access entity after the scan process that the scan process with respect to one parameter is completed and that the buffered packets may be sent from the access entity to the device for wireless communication.

22. The device according to claim 21, wherein the indication that the scan process with respect to the parameter is completed is sending a Poll frame.

23. The device according to claim 21, wherein the indication that the scan process with respect to the parameter is completed is a frame with power management bit cleared.

24. The device according to claim 14, wherein the network is a Wireless Local Area Network (WLAN), the access entity is an Access Point (AP) and the device for wireless communication is a WLAN device.

25. The device according to claim 14, further comprising means to receive a request from a host device hosting the device for wireless communication and to start the detection in response to reception of this request.

26. The device according to claim 14, wherein the detection means comprises a control block (53), a transceiver (52), an antenna (51) and a memory (54).

27. (canceled)

28. A computer program product for a processing device, comprising software code portions for performing the steps of claim 1 when the program is run on the processing device.

29. The computer program product according to claim 28, wherein the computer program product comprises a computer-readable medium on which the software code portions are stored.

30. The computer program product according to claim 28, wherein the processing means is part of a WLAN device.
